(19) United States
(12) Patent Application Publication
(10) Pub. No.: US 2011/0113634 A1
(43) Pub. Date: May 19, 2011

(54) Eating Utensil Incorporating Dental Flosser

(76) Inventor: Jackson L. Crisp, Sundance, WY (US)

(21) Appl. No.: 12/693,913

(22) Filed: Jan. 26, 2010

Related U.S. Application Data
(62) Division of application No. 12/231,274, filed on Sep. 2, 2008, now abandoned.
(60) Provisional application No. 61/133,106, filed on Jun. 25, 2008.

(51) Int. Cl. A47J 43/28; A61C 15/00

(52) U.S. Cl. 30/123; 132/323

(57) ABSTRACT

An eating utensil such as a disposable plastic fork, spoon, knife, or combination thereof, is combined with a dental flosser and optionally with at least one other oral hygienic device for personal use after eating in a location where oral hygienic facilities may not be otherwise available. In some embodiments the oral hygienic device may be permanently attached to the eating utensil, which can serve as a handle for using the oral hygienic device. In other embodiments the oral hygienic device may be displaced in a snap-off or bend-away manner at score lines to facilitate use of oral hygienic device, either still attached to the utensil or removed for separate use, optionally configured with a thumb-finger grip tab.

### PRIORITY

The present application is a division of application Ser. No. 12/231,274, filed Sep. 2, 2008, claiming priority from provisional application 61/133,106, filed Jun. 25, 2008.

### FIELD OF THE INVENTION

The present invention is in the fields of eating utensils and oral cleaning devices, more particularly the invention relates to an eating utensil that incorporates a dental flosser. Additionally other oral hygienic devices may be incorporated.

### BACKGROUND OF THE INVENTION

Eating activity often involves the use of disposable eating utensils, such as plastic forks, spoons and/or knives, typically at away-from-home locations where facilities for oral cleaning after eating are unavailable. Such eating activity may include planned picnics, picnics-on-the-go, fast food, takeout, lunch boxes, bagged lunches at work, eating-on-the-go, delivered specialties, catered food engagements, entertainment events, birthdays, cocktail-parties, weddings and other parties.

### DISCUSSION OF KNOWN ART

U.S. design Pat. D254,239 to Julius shows the ornamental design for a COMBINED FORK AND SEPARATABLE TOOTHPICK.

U.S. design Pat. D463,221 to Sanders for EATING UTENSIL WITH TOOTHPICK INCORPORATED THEREIN shows a fork, spoon and knife each with a presumably removable toothpick located on the front side near the handle end.

U.S. Pat. No. 2,877,547 for COMBINATION TOOTHPICK AND STIRRING OR EATING IMPLEMENT to Feaster discloses wooden spoons, forks and stirring sticks configured with knockout-removable toothpicks.

U.S. Pat. No. 2,072,777 to Takahashi for CUTLERY shows a spoon and a fork each with a pair of toothpicks removably attached on the rear side.

U.S. Pat. No. 3,664,020 to Hammond et al for COMBINATION SPOON AND TOOTHPICK shows and discloses a toothpick and spoon combination including a handle portion with a separable toothpick member for use after eating. The combination utilizes support members from which the toothpick may be broken away.

### OBJECTS OF THE INVENTION

It is a primary object of the present invention to provide disposable plastic utensil embodiments incorporating a dental flosser with one or more optional additional oral hygienic devices, e.g. a dental tongue cleaner and/oral brush, for maintaining good oral hygiene and health at eating events where oral hygienic devices may not be otherwise available.

It is a further object to provide snap-off embodiments wherein an dental flosser, initially formed attached to the utensil handle, can be user-displaced in a snap-off manner and removed for separate usage, and further, to provide bend-away embodiments wherein said dental flosser, permanently attached to utensil handle, can be user-displaced in a bend-away manner presenting dental flosser in different orientations, ready for use.

### SUMMARY OF THE INVENTION

The foregoing objects have been met in the present invention wherein a plastic eating utensil is combined with a dental flosser that can be molded integrally with the utensil handle, initially attached to the handle. Preferably dental flosser is permanently attached with the utensil handle, but can also be user-displaceable in different embodiments as either non-separation bend-away or snap-off separation, depending on design choice of plastic material for resilience, and of score line configuration.

### BRIEF DESCRIPTION OF THE DRAWINGS

The above and further objects, features and advantages of the present invention will be more fully understood from the following description taken with the accompanying drawings.

FIG. 1 shows a front view of a fork with a dental flosser at the end region of eating utensil handle.

FIG. 2 shows a front view of a spork with a dental flosser at the end region of eating utensil handle.

FIG. 3 shows a front view of a knife with a dental flosser and a tongue cleaner at the end region of eating utensil handle.

FIG. 4 shows a back view of a knife with a dental flosser and an oral brush at the end region of eating utensil handle.

FIG. 5 shows a side view of an eating utensil handle with a dental flosser, tongue cleaner and oral brush at the end region of eating utensil handle.

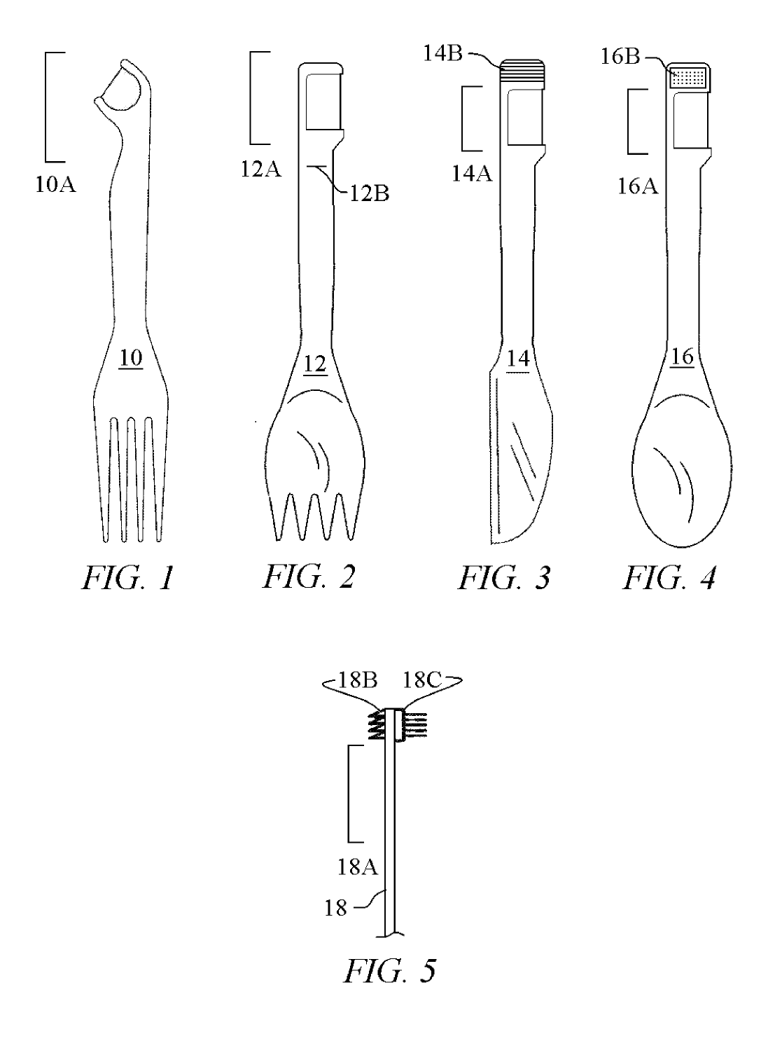

NOTE: It is to be understood that the invention can be practiced with any one of the four alternatives [fork (FIG. 1), spork (FIG. 2), knife (FIG. 3), or spoon (FIG. 4)] disclosed for the eating utensil portion, in conjunction with a flosser, with optional further incorporation of one or more additional oral hygienic devices.

### DETAILED DESCRIPTION

FIG. 1 depicts a fork 10 in combination with an attached dental flosser 10A, ready to use. The floss in dental flosser 10A can be molded into the plastic at manufacture.

FIG. 2 depicts a spork 12 in combination with an attached dental flosser 12A, ready to use. Score line 12B enables a user to displace dental flosser 12A; in a bend-away embodiment, dental flosser 12A remains attached to the spork 12 during a user initiated bend-away event, whereas in a snap-off embodiment, dental flosser 12A is snap-away removed from spork 12. At least one score line can be added to the invention as required/needed.

FIG. 3 depicts a knife 14 in combination with an attached dental flosser 14A; and a tongue cleaner 14B located at the end region of knife 14 handle. A tongue cleaner can be integrally incorporated with the utensil handle in the form of: one to many rows of ridges; an array of raised bumps/features; at least one scraping edge; and/or at least one opening configured to allow debris, from a tongue scraping action, to pass thru, preferably to a designated collection area.

FIG. 4 depicts a spoon 16 in combination with an attached dental flosser 16A; and an oral brush 16B located at the end region of spoon 16 handle. Optionally an oral brush can be implemented as any type of brush that can be used orally, e.g. bristle-type oral brush, interdental-type oral brush, pad/fabricated-type of brush and combinations thereof. An oral brush can be directly molded into the eating utensil handle and/or procured separately and affixed to the handle. A bristle-type oral brush can vary in such areas as, but not limited to, count, arrangement, stiffness, color, width, length, material, attachment method to base and combinations thereof.

FIG. 5 depicts a eating utensil handle 18 in combination with an attached dental flosser 18A; a tongue cleaner 18B and an oral brush 18C located at the end region of eating utensil handle 18.

In FIGS. 1-5 two dental flosser orientations (angled and vertical) are depicted however it is to be understood that the dental flosser is not limited in the orientations in which it could be arranged with respect to the eating utensil handle.

Alternatively, an eating utensil handle portion configured with a dental flosser and/or at least one other hygienic device could also be configured with at least one permanent bend and/or contoured surface to position said hygienic device in such a way so as to aid a user in reaching various regions/areas of the tongue, teeth and mouth.

While the invention is directed primarily to an unfulfilled need and expected demand in conjunction with disposable plastic eating utensils which are likely to be popular at picnics and other social or public eating events where regular dental cleaning facilities are unavailable, the invention could be practiced in conjunction with more permanent type eating utensils intended for more general use. The material in the eating utensil can be metal or any material that can provide the desired break-away or bend-back embodiment. As an alternative to the generally one-piece construction shown for the eating utensil, it could be made from a plurality of parts joined by fastenings such as mechanical fasteners, welding or adhesives. In consideration of the environment plastics of a biodegradable type could be used.

Standard fork or spoon designs could include, but are not limited to, such features as ribbed-supports and similar structural/cosmetic elements.

To deploy a dental flosser where displacement from the initial location is required. Such displacement can be implemented as one of two basic approaches: snap-off or bend-away displacement, depending on design selection of handle material for resilience and the characteristics of special displacement-related configurations known as score lines in the handle material, i.e. lines in which the basic handle strength is reduced locally e.g. by slots, V-grooves, perforations, embossing, etc., configured on one or both sides of the handle and having the effect of reduced material thickness and thus reduced strength along the score line(s). In the design of snap-off embodiments, the material is selected to be relatively brittle and the score line depth is made to enable a user to break the material at the score line. Generally the depth of the score line is chosen to make snap-off easy and convenient, however in special embodiments that require initial stiffness, the score line is made shallower, requiring greater force for snap-off separation. Bend-away embodiments could also implement a score line configured as a living hinge, allowing for flexion of the flosser head. The living hinge and integrated handle portion areas could be construction using multiple parts and/or types of plastics.

As alternatives to the dental cleaning devices being attached to the eating utensil in a permanent or break-away manner with score lines as shown, the invention could be practiced with such attachment made by other fasteners such as temporary glue, magnets, snap-fits, Velcro or the like. It could be arranged for break-away parts to be re-attached.

The eating utensil handle could incorporated at least one other hygienic device selected from interdental pick-brushes, interdental picks, oral brushes and tongue cleaners, integrated into the eating utensil by attachment means such as mold-integration, adhesive or welding, or alternatively bundled in an eating-kit package including one or more eating utensils and/or related items such as a napkin.

As an alternative to floss where a flosser is shown, a rigid, semi-rigid or flexible thin fin or blade could be provided to clean between and around the teeth.

As an alternative to the flosser with a piece of floss suspended between two prongs as shown, the floss could be provided stored in the eating utensil body, attached loose thereto or bundle-wrapped. Flossers could contain to floss portions and/or multiple floss segments.

As an alternative to incorporating the dental cleaning device within or directly attached to the eating utensil, one or more cleaning device and/or one or more eating utensil could be included separately side-by-side in sheet of plastic made and arranged to enable break-away removal for use.

Supplemental items such as dental floss, tissue paper or mouth wash could be provided either separately, stored within or attached to the eating utensil body in some manner, optionally bundle-wrapped and/or hygienic eating utensils could be individually wrapped.

The invention may be embodied and practiced in other specific forms without departing from the spirit and essential characteristics thereof. The present embodiments are therefore to be considered in all respects as illustrative and not restrictive, the scope of the invention being indicated by the appended claims rather than by the foregoing description; and all variations, substitutions and changes which come within the meaning and range of equivalency of the claims are therefore intended to be embraced therein.

1. A combination eating utensil and dental flosser comprising:
an eating utensil portion of a type selected from a group consisting of forks, spoons, knives and combinations thereof;
a handle portion mold incorporated with said eating utensil portion, extending from said eating utensil portion to an end region of the handle portion;
a dental flosser mold incorporated with said handle portion, having two ends defining a flosser opening formed in conjunction with said handle portion; and
a length of dental floss mold incorporated at each of the two ends of said dental flosser, extending across the flosser opening.

2. A combination eating utensil and dental flosser comprising:
an eating utensil portion of a type selected from a group consisting of forks, spoons, knives and combinations thereof;
a handle portion permanently attached to said casting utensil portion, extending from said eating utensil portion to an end region of the handle portion;
a dental flosser permanently attached to said handle portion, having two ends defining a flosser opening formed in conjunction with said handle portion; and
a length of dental floss permanently attached at each of the two ends of said dental flosser, extending across the flosser opening.

3. A combination eating utensil and dental flosser comprising:
an eating utensil portion of a type selected from a group consisting of forks, spoons, knives and combinations thereof;
a handle portion extending from said eating utensil portion to an end region of the handle portion;
a dental flosser having two ends defining a flosser opening formed in conjunction with said handle portion; and
a length of dental toss attached at each of the two ends of said dental flosser, extending across the flosser opening.

4. The combination eating utensil and dental flosser as defined in claim 3 further comprising:
said dental flosser being formed from the end region of said handle portion, the two ends of said flosser opening and the length of floss being located offset from a center line between two side edges of said handle portion; and
said handle portion being configured to form a substantially narrowed region at the first side edge of said handle portion in a region adjacent to said dental flosser, for purposes of facilitating flosser usage.

5. The combination eating utensil and dental flosser as defined in claim 3 further comprising:
said dental flosser being formed from the end region of said handle portion, the two ends of said flosser opening and the length of floss being located perpendicular to the center line between two side edges of said handle portion.

6. The combination eating utensil and dental flosser as defined in claim 3 further comprising:
said dental flosser being formed from the end region of said handle portion, the two ends of said flosser opening and the length of floss being located parallel to a center line between two side edges of said handle portion; and
said handle portion being configured to form a narrowed region at the second side edge of said handle portion in a region adjacent to said dental flosser.

7. The combination eating utensil and dental flosser as defined in claim 3 further comprising:
a tongue cleaner located endmost in said end region of said handle portion; and
said dental flosser being located next-to-endmost region of said handle portion, the two ends of said flosser opening and the length of floss being located parallel to the center line between two side edges of said handle portion.

8. The combination eating utensil and dental flosser as defined in claim 3 further comprising:
an oral brush located endmost in said end region of said handle portion; and
said dental flosser being located next-to-endmost region of said handle portion, the two ends of said flosser opening and the length of floss being located parallel to the center line between two side edges of said handle portion.

9. The combination eating utensil and dental flosser as defined in claim 3 further comprising:
an oral brush and a tongue cleaner located endmost in said end region of said handle portion; and
said dental flosser being located next-to-endmost region of said handle portion, the two ends of said flosser opening and the length of floss being located parallel to the center line between two side edges of said handle portion.

10. The combination eating utensil and dental flosser as defined in claim 3 wherein said dental flosser is located in the end region of said handle portion, the end region being demarked by a lateral bend line at which a bend placed in said handle is made to hold the end region including said dental flosser for use at a predetermined angle of inclination.

11. The combination eating utensil and dental flosser as defined in claim 3 wherein;
said length of dental floss is permanently attached at each of two ends of said dental flosser in a molding process.

12. The combination eating utensil and dental flosser as defined in claim 3 wherein;
said handle portion being permanently attached to said eating utensil portion; and
said dental flosser being permanently attached to said handle portion.

13. The combination eating utensil and dental flosser as defined in claim 3 further comprising:
said dental flosser being formed from material of said handle portion, the two ends of said flosser opening and the length of floss being located offset from a center line between two side edges of said handle portion.

14. The combination eating utensil and dental flosser as defined in claim 3 further comprising:
said dental flosser being formed from material of said handle portion, the two ends of said flosser opening and the length of floss being located non-perpendicular to a center line between two side edges of said handle portion.

15. The combination eating utensil and dental flosser as defined in claim 3 further comprising:
said dental flosser being formed from material of said handle portion, the two ends of said flosser opening and the length of floss being located perpendicular to the center line between two side edges of said handle portion.

16. The combination eating utensil and dental flosser as defined in claim 3 further comprising:
said dental flosser being formed from material of said handle portion, the two ends of said flosser opening and the length of floss being located parallel to the center line between two side edges of said handle portion.

17. The combination eating utensil and dental flosser as defined in claim 3 further comprising:
an oral hygienic device located endmost in said end region of said handle portion; and
said dental flosser being located next-to-endmost region of said handle portion, the two ends of said flosser opening and the length of floss being located parallel to the center line between two side edges of said handle portion.

18. The combination eating utensil and dental flosser as defined in claim 3 wherein said hygienic device is a spork.

19. The combination eating utensil and dental flosser as defined in claim 3 further comprising at least one additional oral hygienic device.

20. The combination eating utensil and dental flosser as defined in claim 3 configured with at least one score line, located on said handle portion, enabling snap off and removal of said flosser portion.
